(19) United States
(12) Patent Application Publication
(10) Pub. No.: US 2024/0331930 A1
(43) Pub. Date: Oct. 3, 2024

(54) ELECTRONIC COMPONENT

(71) Applicant: TDK CORPORATION, Tokyo (JP)

(72) Inventors: Hokuto EDA, Tokyo (JP); Hitoshi OHKUBO, Tokyo (JP); Masazumi ARATA, Tokyo (JP); Kohei TAKAHASHI, Tokyo (JP); Takamasa IWASAKI, Tokyo (JP)

(73) Assignee: TDK CORPORATION, Tokyo (JP)

(21) Appl. No.: 18/616,800

(22) Filed: Mar. 26, 2024

(30) Foreign Application Priority Data
Mar. 29, 2023 (JP) 2023-053772

(51) Int. Cl. H01F 27/29; H01F 27/28; H01F 27/32

(52) U.S. Cl. CPC H01F 27/292; H01F 27/2804; H01F 27/323; H01F 2027/2809

(57) ABSTRACT

A coil component, which is a kind of electronic component, is designed such that the resistivity of second electrode layers of external terminal electrodes are lower than the resistivity of first electrode layers. Therefore, the electric resistance when the voltage is applied between the external terminal electrodes and the current flows through the portion covering end surfaces is reduced as a whole of the external terminal electrode as compared with the electric resistance of an external terminal electrode constituted only by the first electrode layer.

### CROSS-REFERENCE TO RELATED APPLICATIONS

This application is based upon and claims the benefit of priority from Japanese Patent Application No. 2023-53772, filed on 29 Mar. 2023, the entire content of which is incorporated herein by reference.

### TECHNICAL FIELD

The present disclosure relates to electronic components.

### BACKGROUND

Well known in the art is an electronic component such as a coil component surface-mounted on a mounting substrate. Japanese Patent Application Publication No. 2017-34227 discloses a coil component including an external terminal electrode continuously extending from a mounting surface to a side surface of an element body, and a coil conductor having an end portion exposed to the side surface of the element body and connected to the external terminal electrode.

### SUMMARY

In the above-described coil component according to the related art, since the external terminal electrode is exposed, it is difficult to mount the coil components at high density due to a short circuit. In order to prevent such short-circuiting, it is possible to cover a portion of the external terminal electrode covering the side surface of the element body with insulating material, but in this case, the electric resistance may be high.

According to various aspects of the present disclosure, there is provided an electronic component capable of reducing electric resistance in an external terminal electrode.

An electronic component according to one aspect of the present disclosure includes an element body including a mounting surface and a side surface extending in a direction intersecting the mounting surface, an external terminal electrode extending continuously from the mounting surface to the side surface of the element body, a conductor provided in the element body and having an end portion exposed to the side surface of the element body and connected to the external terminal electrode, and an insulation layer covering a portion covering the side surface of the element body of the external terminal electrode, wherein the external terminal electrode includes a first electrode layer directly covering the mounting surface and the side surface of the element body and in contact with the end portion of the conductor, and a second electrode layer covering the first electrode layer and having a lower resistivity than that of the first electrode layer.

In the electronic component, since the resistivity of the second electrode layer of the external terminal electrode is lower than the resistivity of the first electrode layer, the whole resistance of the external terminal electrode is reduced.

### BRIEF DESCRIPTION OF THE DRAWINGS

FIG. 1 shows a schematic perspective view of a coil component according to one embodiment.

FIG. 2 shows an exploded perspective view of the coil component shown in FIG. 1.

FIG. 3 shows an exploded perspective view of the configuration of the substrate and the coil conductor.

FIG. 4 shows a cross-sectional view taken along line IV-IV of the coil component shown in FIG. 1.

FIG. 5 shows a cross-sectional view taken along line V-V of the coil component shown in FIG. 1.

FIG. 6 shows an enlarged view of the cross-sectional view shown in FIG. 4.

### DETAILED DESCRIPTION

Hereinafter, embodiments of the present disclosure will be described in detail with reference to the accompanying drawings. In the description, the same reference numerals are used for the same elements or elements having the same functions, and redundant description will be omitted.

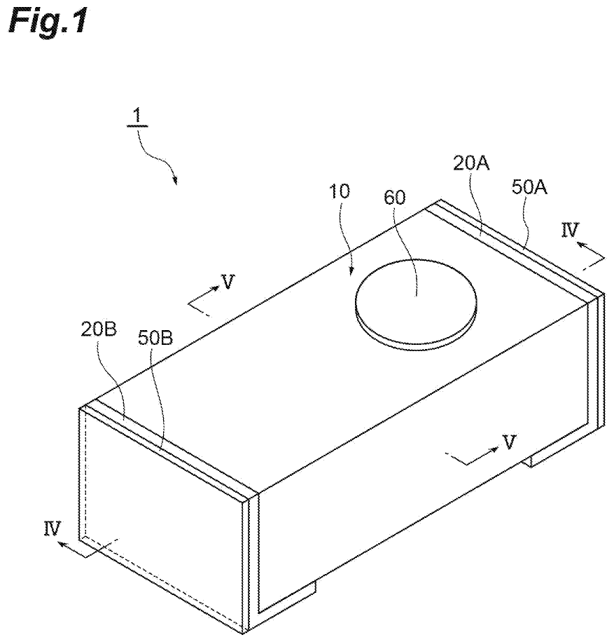

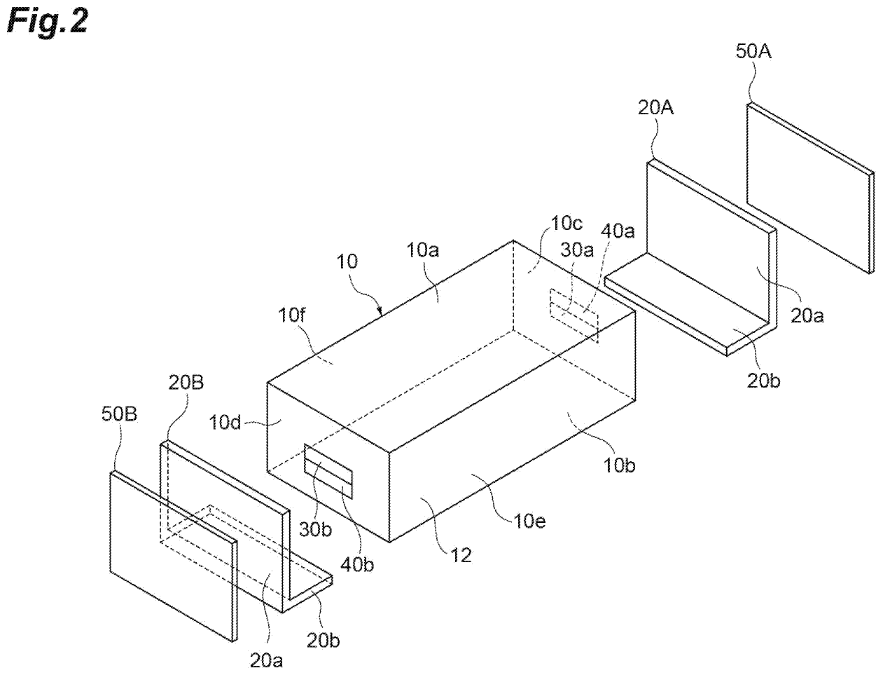

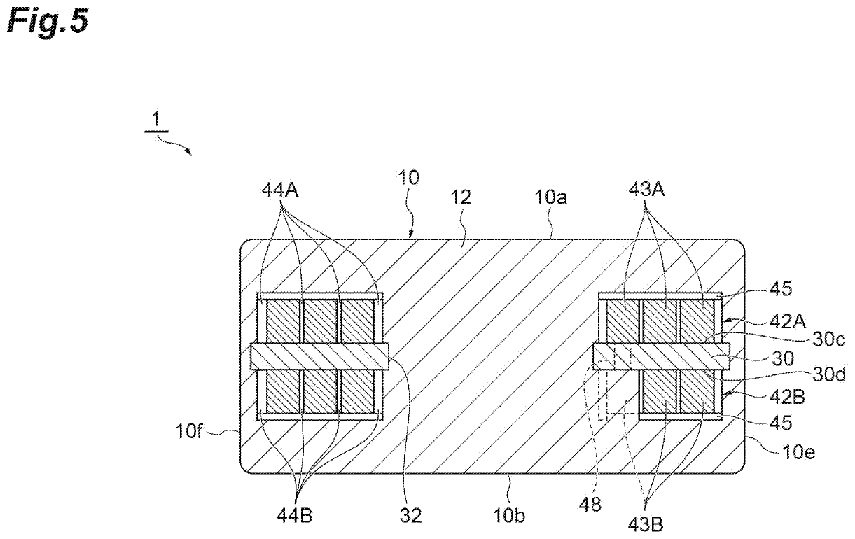

A coil component 1 according to one embodiment, which is one type of electronic components, will be described with reference to FIGS. 1 to 5. As shown in FIGS. 1 and 2, the coil component 1 includes an element body 10, a pair of external terminal electrodes 20A and 20B provided on the surface of the element body 10, and a pair of insulation layers 50A and 50B covering the pair of the external terminal electrodes 20A and 20B from the outside.

The element body 10 has a substantially rectangular parallelepiped outer shape and includes a pair of main surfaces 10a and 10b facing each other and two pairs of side surfaces 10c to 10f extending in a direction intersecting each of main surfaces 10a and 10b to connect the main surfaces 10a and 10b. The two pairs of side surfaces 10c to 10f includes a pair of end surfaces 10c and 10d facing each other and a pair of side surfaces 10e and 10f facing each other. In the present embodiment, the facing direction of the pair of main surfaces 10a and 10b is the height direction of the element body 10, the facing direction of the pair of end surfaces 10c and 10d is the long side direction of the element body 10, and the facing direction of the pair of side surfaces 10e and 10f is the short side direction of the element body 10. In the present embodiment, the main surface 10b is a mounting surface facing a substrate on which the coil component 1 is mounted. The coil component 1, as an example, is designed with dimensions of a longer side 2.0 mm, a shorter side 1.25 mm, height 1.0 mm.

In the present embodiment, a mark 60 for determining the direction and polarity of the coil component 1 is provided at a position biased toward the end surface 10c on the main surface 10a. The pair of main surfaces 10a and 10b of the element body 10 may be entirely covered with an insulation layer to increase insulation of the surface.

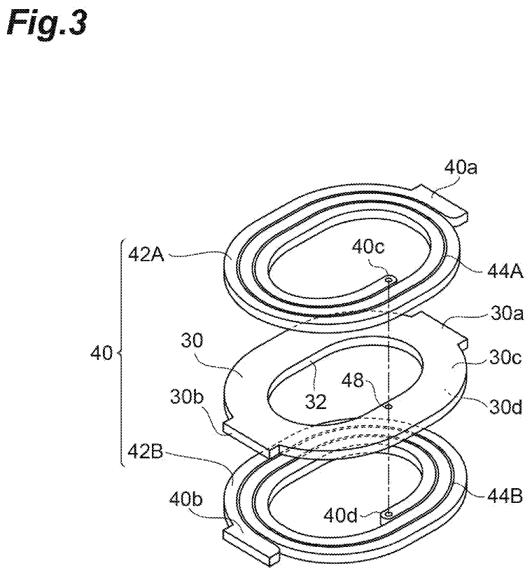

The element body 10 is configured to include a substrate 30 shown in FIG. 3 and a coil conductor 40 provided inside a magnetic body 12.

The substrate 30 is provided inside the element body 10 and extends between the pair of end surfaces 10c and 10d in the element body 10. The substrate 30 has end portions 30a and 30b exposed from the end surfaces 10c and 10d. The substrate 30 has a flat plate shape extending parallel to the main surfaces 10a and 10b of the element body 10. The substrate 30 has an upper surface 30c located on the main surface 10a side and a lower surface 30d located on the main surface 10b side. The substrate 30 has a substantially elliptical annular shape when viewed from the thickness direction. An elliptical through hole 32 is provided in a central portion of the substrate 30.

The substrate 30 is made of nonmagnetic insulating material. As the substrate 30, substrate obtained by impregnating glass cloth with epoxy-based resin and having thickness of 10 μm to 60 μm can be used. In addition to the epoxy resin, BT resin, polyimide, aramid, or the like may be used. Ceramic or glass can also be used as the material of the substrate 30. The material of the substrate 30 may be mass-produced printed substrate material or resinous material used for BT printed-circuit board, FR4 printed-circuit board, or FR5 printed-circuit board.

The coil conductor 40 includes a first coil part 42A, a second coil part 42B, and a through-hole conductor 48. The first coil part 42A includes a first conductor pattern 43A insulation-coated for a planar air-core coil provided on the upper surface 30c of the substrate 30. The second coil part 42B includes a second conductor pattern 43B insulation-coated for a planar air-core coil provided on a lower surface 3d of the substrate 30. The through-hole conductor 48 connects the first conductor pattern 43A and the second conductor pattern 43B.

The first conductor pattern 43A is a planar spiral pattern serving as a planar air-core coil, and is formed by plating with conductor material such as Cu. The first conductor pattern 43A is configured to wind around the through hole 32 of the substrate 30. More specifically, as shown in FIG. 3, the first conductor pattern 43A is wound clockwise by three turns outward when viewed from above.

An outer end portion 40a of the first conductor pattern 43A is exposed at the end surface 10c of the element body 10 and is connected to the external terminal electrode 20A that covers the end surface 10c. An inner end portion 40c of the first conductor pattern 43A is connected to the through-hole conductor 48.

Similar to the first conductor pattern 43A, the second conductor pattern 43B has a planar spiral pattern serving as a planar air-core coil and is formed by plating with conductor material such as Cu. The second conductor pattern 43B is also configured to wind around the through hole 32 of the substrate 30. More specifically, the second conductor pattern 43B is wound counterclockwise by three turns outward when viewed from above. In other words, the second conductor pattern 43B is wound in a direction opposite to the first conductor pattern 43A when viewed from above.

An outer end portion 40b of the second conductor pattern 43B is exposed at the end surface 10d of the element body 10 and is connected to the external terminal electrode 20B that covers the end surface 10d. An inner end portion 40d of the second conductor pattern 43B is aligned with the inner end portion 40c of the first conductor pattern 43A in the thickness direction of the substrate 30 and connected to the through-hole conductor 48.

The through-hole conductor 48 is provided through the edge region of the through-hole 32 of the substrate 30, and connects the inner end portion 40c of the first conductor pattern 43A and the inner end portion 40d of the second conductor pattern 43B. The through-hole conductor 48 may consist of a hole provided in the substrate 30 and conductive material (for example, metallic material such as Cu) filled in the hole. The through-hole conductor 48 has, as an example, a columnar (e.g., cylindrical or prismatic) outer shape extending in the thickness direction of the substrate 30.

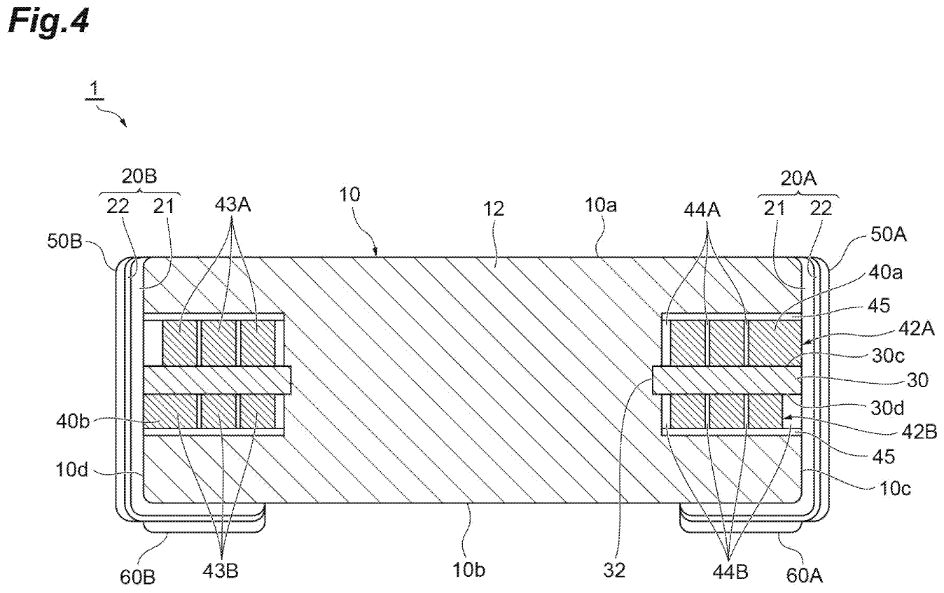

As shown in FIG. 4, the first coil portion 42A and the second coil portion 42B have resin walls 44A and 44B, respectively. The resin wall 44A of the first coil portion 42A is located between the wires of the first conductor pattern 43A, on the inner periphery and on the outer periphery of the wires of the first conductor pattern 43A. Similarly, the resin wall 44B of the second coil portion 42B is located between the wires of the second conductor pattern 43B, on the inner periphery and on the outer periphery of the wires of the second conductor pattern 43B. In the present embodiment, the resin walls 44A and 44B at the inner and outer peripheries of the conductor patterns 43A and 43B are designed to be thicker than the resin walls 44A and 44B located between the wires of the conductor patterns 43A and 43B.

The resin walls 44A and 44B are made of insulating resinous material. The resin walls 44A and 44B can be provided on the substrate 30 before the first conductor pattern 43A and the second conductor pattern 43B are formed, in which case the first conductor pattern 43A and the second conductor pattern 43B are plated and grown in areas defined by the resin walls 44A and 44B. The resin walls 44A and 44B can be provided on the substrate 30 after the first conductor pattern 43A and the second conductor pattern 43B are formed, and in which case, the resin walls 44A and 44B are formed by filling, coating or the like on the first conductor pattern 43A and the second conductor pattern 43B.

Each of the first coil portion 42A and the second coil portion 42B is provided with insulation layers 45 that integrally covers the first conductor pattern 43A, the second conductor pattern 43B, the resin walls 44A and 44B from above and below. The insulation layer 45 may be made of insulating resin or insulating magnetic material.

The magnetic body 12 integrally covers the substrate 30 and the coil conductor 40. Specifically, the magnetic body 12 covers the substrate 30 and the coil conductor 40 from above and below and covers the outer peripheries of the substrate 30 and the coil conductor 40. The magnetic body 12 also fills the interior of the substrate 30 through-hole 32 and the inner region of the coil conductor 40. The magnetic body 12 constitutes all surfaces of the element body 10, i.e. the main surfaces 10a and 10b, the end surfaces 10c and 10d, the side surfaces 10e and 10f.

The magnetic body 12 is made of a metal magnetic powder-containing resin. The metal magnetic powder-containing resin is a bound powder in which metal magnetic powder is bound by binder resin. The metal magnetic powder of the metal magnetic powder-containing resin constituting the magnetic body 12 contains metal magnetic powder containing at least Fe (e.g., iron-nickel alloy (i.e., permalloy), carbonyl iron, FeSiCr based alloy in state of amorphous, non-crystal or crystal, sendust, etc.). The binder resin is, as an example, a thermosetting epoxy resin. In the present embodiment, the content of the metal magnetic powder in the bounded powder is 80 to 92 vol % in terms of volume percent, and 95 to 99 wt % in terms of weight percent. From the viewpoint of magnetic properties, the content of the metal magnetic powder in the bound powder may be 85 to 92 vol % in terms of volume percent and 97 to 99 wt % in terms of weight percent. The magnetic powder constituting the magnetic body 12 may be powder having one kind of average particle diameter or a mixed powder having a plurality of kinds of average particle diameters. In the case where the metal magnetic powder of the metal magnetic powder-containing resin constituting the magnetic body 12 is mixed powder, the kinds of the magnetic powder having different average particle diameters and the Fe composition ratio may be the same or different.

Of the pair of the external terminal electrodes 20A and 20B, the first external terminal electrode 20A is provided on the end surface 10c side of the element body 10. The first external terminal electrode 20A includes a portion 20a covering a part or a whole of the end surface 10c and a portion 20b covering a part of the main surface 10b on the end surface 10c side, and has an L-shape continuously covering the end surface 10c and the main surface 10b.

Of the pair of the external terminal electrode 20A and 20B, the second external terminal electrode 20B is provided on the end surface 10d side of the element body 10. Similar to the first external terminal electrode 20A, the second external terminal electrode 20B includes a portion 20a covering a part or a whole of the end surface 10d and a portion 20b covering a part of the main surface 10b on the end surface 10d side, and has an L-shape continuously covering the end surface 10d and the main surface 10b. In the present embodiment, the portions 20a covering the end surfaces 10c and 10d of the external terminal electrodes 20A and 20B extend to height position reaching the upper ends of the end surfaces 10c and 10d. The portions 20a may not extend to the height position reaching the upper end of the end surfaces 10c and 10d.

Each of the external terminal electrodes 20A and 20B has a multilayer structure, and has a two-layer structure composed of a first electrode layer 21 and a second electrode layer 22 in the present embodiment. Each of the external terminal electrodes 20A and 20B may have a multilayer structure of three or more layers.

Each of the first electrode layers 21 is located on the surface of the element body 10 and directly covers the main surface 10b and the end surfaces 10c and 10d. Each of the first electrode layers 21 can be made of resinous electrode material, as an example. In the present embodiment, each of the first electrode layers 21 is an Ag-resin electrode made of resinous electrode material containing Ag powder. The first electrode layer 21 of the external terminal electrode 20A is in contact with and electrically connected to the outer end portion 40a of the first conductor pattern 43A exposed at the end surface 10c. The first electrode layer 21 of the external terminal electrode 20B is in contact with and electrically connected to the outer end portion 40b of the second conductor pattern 43B exposed at the end surface 10d.

Each of the second electrode layers 22 is located on the first electrode layer 21 and entirely cover the first electrode layer 21. Each of the second electrode layers 22 can be formed by metallic plating, as an example. In the present embodiment, each of the second electrode layers 22 is a Ni-plated electrode made of nickel. The resistivity of the second electrode layer 22 is designed to be lower than the resistivity of the first electrode layer 21.

The pair of the insulation layers 50A and 50B cover the portions 20a covering the end surfaces 10c and 10d of the external terminal electrodes 20A and 20B, respectively. In the present embodiment, each of the insulation layers 50A and 50B directly cover the second electrode layers 22 in the external terminal electrodes 20A and 20B. Each of the insulation layers 50A and 50B is made of insulating material such as resin.

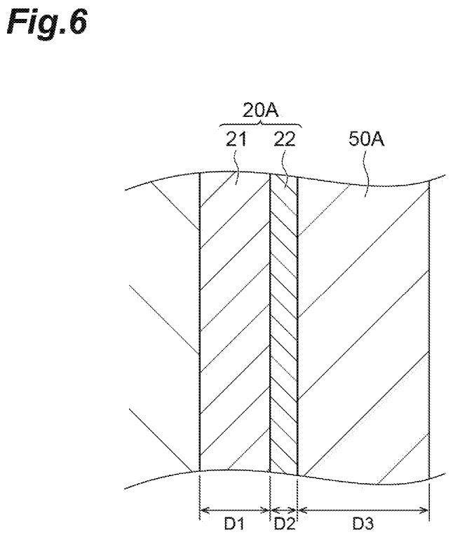

In the present embodiment, the thicknesses of the first electrode layer 21 and the second electrode layer 22 of the insulation layers 50A and 50B and the external terminal electrodes 20A and 20B have the relationship shown in FIG. 6. That is, the thickness D1 of the first electrode layer 21 of the external terminal electrodes 20A and 20B is larger than the thickness D2 of the second electrode layer 22 of the external terminal electrodes 20A and 20B (D1>D2). The thickness D3 of the insulation layers 50A and 50B is larger than any of the thickness D1 of the first electrode layer 21 and the thickness D2 of the second electrode layer 22 of the external terminal electrodes 20A and 20B (D3>D1 and D3>D2). The thickness D3 of the insulation layers 50A and 50B may be equal to or less than the thickness D1 of the first electrode layer 21 of the external terminal electrodes 20A and 20B, and may be larger than the thickness D2 of the second electrode layer 22 (D1>D3 and D3>D2).

In the pair of the external terminal electrodes 20A and 20B, since the portions 20a covering the end surfaces 10c and 10d are covered with the insulation layers 50A and 50B, the coil components 1 can be mounted at high density while avoiding an electric short circuit. Since the portions 20b covering the main surface 10b is not covered with the insulation layers 50A and 50B but exposed from the insulation layers 50A and 50B, surface mounting can be performed by using the portions 20b covering the main surface 10b of the external terminal electrodes 20A and 20B. In the present embodiment, as shown in FIG. 4, electrode layers 60A and 60B are provided on the portions 20b covering the main surface 10b of the external terminal electrodes 20A and 20B, respectively. Each electrode layer 60A and 60B can be used to further improve mountability, and can be formed of, as an example, a plated electrode (e.g., a Sn-plated electrode). By providing the electrode layers 60A and 60B after covering the external terminal electrodes 20A and 20B with the insulation layers 50A and 50B, the electrode layers 60A and 60B can be provided on a whole of the portions 20b of the external terminal electrodes 20A and 20B which are not covered with the insulation layer 50A and 50B.

The coil component 1 is designed so that the resistivity of the second electrode layer 22 of each of the external terminal electrodes 20A and 20B is lower than that of the first electrode layer 21. Therefore, the electric resistance when a voltage is applied between the external terminal electrodes 20A and the 20B and current flows in the portion 20a covering the end surface 10c and 10d is reduced as a whole of the external terminal electrode as compared with the electric resistance of the external terminal electrode constituted only by the first electrode layer 21. The higher the ratio D2/D1 between the thicknesses of the first electrode layer 21 and the second electrode layer 22, the lower the electric resistance of the external terminal electrode as a whole can be. Further, by using the resinous electrode material for the first electrode layer 21, it is possible to improve the mounting strength of the coil component 1.

The electronic component described above is not limited to the configuration described above, and various configurations can be adopted. For example, the electronic component is not limited to the coil component, and may be a capacitor, a varistor, an inductor, or the like. The coil of the coil component is not limited to a plated coil patterned in a planar spiral shape, and may be a helical coil or the like in which a conductive wire is helically wound.

What is claimed is:

1. An electronic component comprising:
an element body including a mounting surface and a side surface extending in a direction intersecting the mounting surface;
an external terminal electrode extending continuously from the mounting surface to the side surface of the element body; and
a conductor provided in the element body and having an end portion exposed to the side surface of the element body and connected to the external terminal electrode; and
an insulation layer covering a portion covering the side surface of the element body of the external terminal electrode,
wherein the external terminal electrode includes a first electrode layer directly covering the mounting surface and the side surface of the element body and in contact with the end portion of the conductor, and a second electrode layer covering the first electrode layer and having a lower resistivity than that of the first electrode layer.

2. The electronic component of claim 1, wherein the first electrode layer is made of resin electrode material.

3. The electronic component of claim 1, wherein the first electrode layer is thicker than the second electrode layer.

4. The electronic component according to claim 1, wherein in a portion covering the mounting surface of the element body of the external terminal electrode, the second electrode layer is exposed from the insulation layer.
